(19) United States
(12) Patent Application Publication
(10) Pub. No.: US 2010/0280184 A1
(43) Pub. Date: Nov. 4, 2010

(54) SURFACE FUNCTIONALISATION OF PLASTIC OPTICAL FIBRE

(76) Inventor: Barry Colin Crane, Oxfordshire (GB)

Correspondence Address: FISH & RICHARDSON P.C., PO BOX 1022, MINNEAPOLIS, MN, 55440-1022, US

(21) Appl. No.: 12/811,949

(22) PCT Filed: Jan. 7, 2009
(86) PCT No.: PCT/GB09/00027

§ 371 Date: Jul. 7, 2010

(30) Foreign Application Priority Data
Jan. 8, 2008 (GB) 0800278.4

(51) Int. Cl. C08F 283/01

(52) U.S. Cl. 525/288

(57) ABSTRACT

A process is provided for the covalent attachment of an indicator to a plastic optical fibre by functionalising the surface of the optical fibre to provide a polymerisable group, and polymerising an indicator monomer, optionally together with a hydrogel-forming monomer, to the fibre surface. This provides an optical fibre having covalently linked to its surface an indicator, typically an indicator encased in a hydrogel. The plastic optical fibre is useful as a sensor.

The present invention relates to the functionalisation of a plastic optical fibre to immobilise an indicator thereon, and to plastic optical fibres which are covalently bound to an indicator or to a polymer including the indicator.

### BACKGROUND TO THE INVENTION

Optical fibres have in recent years found use as chemical or biological sensors, in particular in the field of invasive or implantable sensor devices. Such optical fibre sensors typically involve an indicator, whose optical properties are altered in the presence of the analyte of interest. For example, fluorophores having a receptor capable of binding to the target analyte have been used as indicators in such sensors. Optical fibres have been produced from glass and from plastic, but plastic fibres are preferred due to the reduced frequency of breakage.

Attachment of the indicator to a plastic optical fibre can be achieved by physically entrapping the indicator in a polymer matrix such as a hydrogel, which is coated onto the plastic fibre. However, such physical entrapment may lead to leakage of the indicator and consequent loss of functionality of the sensor. To address the issue of leakage, indicators have been functionalised and subsequently copolymerised with the matrix material. The resulting copolymer is then coated onto the fibre.

However, this attachment is still not satisfactory since the polymer matrix which results is friable and is easily detached from the optical fibre. An improved technique of attaching indicator chemistries to plastic optical fibres is therefore required.

### SUMMARY OF THE INVENTION

The present invention involves functionalising the plastic fibre itself, and subsequently copolymerising the indicator directly to the fibre. A terpolymer is usually formed including the indicator, fibre and a matrix material such as a hydrogel-forming material.

This achieves covalent immobilisation of the indicator within a hydrogel and concurrently covalent attachment of the hydrogel to the plastic fibre. A secure attachment of indicator to fibre is therefore achieved.

The present invention accordingly provides a process for covalently linking an indicator to a plastic optical fibre, which process comprises:
(i) functionalising a plastic optical fibre to provide a functionalised fibre having one or more polymerisable groups; and
(ii) polymerising the functionalised fibre with an indicator monomer comprising at least one polymerisable group.

In a preferred embodiment, the polymerisation step (ii) involves polymerising the functionalised fibre with an indicator monomer and a matrix-forming monomer such as a hydrogel forming monomer.

Also provided is a plastic optical fibre which is covalently linked to an indicator or to a polymer comprising an indicator and a biosensor comprising the plastic optical fibre.

### DETAILED DESCRIPTION OF THE INVENTION

The present invention is suitable for the linkage of an indicator to the surface of any plastic fibre which can be functionalised so that a reactive group is attached. The plastic material from which the fibre is produced is accordingly not particularly limited. Thermoplastics are often used, for example polymethylmethacrylate, polymethacrylate or polycarbonates, with polymethylmethacrylate being preferred.

The plastic fibre is functionalised so that it includes one or more polymerisable groups on its surface. The polymerisable groups may be, for example, carbon-carbon double bonds, alkoxysilanes for formation of silicones, or carboxylic acid derivatives, alcohols or isocyanates for formation of polyesters or polyurethanes. Typically, carbon-carbon double bonds are used. Any process which leads to the presence of a polymerisable group on the surface of the plastic fibre may be used. In a typical embodiment, the functionalisation step is carried out as a two step process, including (ia) reaction of the fibre with a plasma to provide one or more reactive groups on the surface of the fibre, and (ib) conversion of the or each reactive group to a polymerisable group.

The plasma reaction step typically involves contact of the plastic fibre with a radio frequency plasma. Typically, only the part of the fibre which is to be linked to the indicator (e.g. the tip) is immersed in the plasma. The plasma may be an ammonia plasma or a N₂/H₂ plasma in which case the fibre is functionalised with —NH₂ groups. N₂/H₂ plasmas are preferred since they are non-corrosive in comparison with ammonia. Alternatively an O₂ plasma may be used in which case the fibre is functionalised with —COOH groups. In the case of an N₂/H₂ plasma, typically from about 30 to 60% N₂ is present, for example at least 40%, such as about 45% N₂. The addition of reactive functional groups to plastic materials by use of radiofrequency plasma is known in the art and the skilled person would be familiar with appropriate techniques. For example, to achieve amine functionality on a poly methylmethacrylate fibre the gases used are hydrogen and nitrogen in the composition of 55% and 45% respectively with an RF power of 240 w. At these conditions the amine loading can be maximised.

The reactive group(s) (e.g. amine or carboxyl groups) present on the surface of the fibre are then converted in a step (ib) to polymerisable groups. Typically, this is achieved by reaction of the fibre with a compound comprising (i) a polymerisable group and (ii) a functional group capable of reacting with the amine or carboxyl group on the surface of the fibre. The polymerisable group is, as discussed above, preferably a carbon-carbon double bond. The functional group capable of reacting with an amine group is, for example, an acid chloride or acid anhydride group. The functional group capable of reacting with a carboxyl group is, for example, an amine. Suitable examples of the compound for use in step (ib) therefore include methacryloyl chloride, acryloyl chloride, methacrylic anhydride and acrylic anhydride.

The step (ib) involves a simple synthetic reaction and it would be a routine matter for a skilled chemist to carry out such a reaction. For example an amine-substituted fibre may be reacted at room temperature with acryloyl chloride in a suitable organic solvent such as dry ether. The reaction may be accelerated by addition of a base which reacts with the HCl produced as a by-product. For example, proton sponge (1,8 bis (dimethylamino) naphthalene) may be added to the reaction mixture.

Once the functionalised fibre having one or more polymerisable groups on its surface has been produced, the fibre is subjected to the polymerisation step (ii). This step involves reacting the functionalised fibre with at least an indicator monomer, and optionally further monomers such as chain extenders and/or cross-linkers.

The indicator monomer is an indicator that has been modified as necessary to include a polymerisable group, typically a carbon-carbon double bond. An indicator as used herein is a compound whose optical properties are altered on binding with an analyte. An optical fibre attached to such an indicator can therefore be used as a sensor for the analyte. Typically, an indicator includes a receptor for the analyte and a fluorophore. The emission wavelength of the fluorophore is altered when the analyte is bound to the receptor. Examples of indicators for use in the invention include pH indicators, potassium indicators (e.g. crown ethers) and enzymes which can be altered by attachment of a polymerisable group.

In one embodiment of the invention, a glucose indicator is used. A glucose indicator typically contains a boronic acid receptor which binds to the glucose molecule and a fluorophore such as anthracene. An example of such a glucose indicator is given by Wang et al (referenced below).

An indicator monomer contains a polymerisable group such as a double bond to enable it to participate in the polymerisation step. Typically an indicator monomer is obtained by carrying out an appropriate modification to an indicator to include a double bond in its structure. An example of such modification of an indicator is provided by Wang (Wang, B., Wang, W., Gao, S., (2001). Bioorganic Chemistry, 29, 308-320). This article describes the synthesis of a monoboronic acid glucose receptor linked to an anthracene fluorophore that has been derivatised with a methacrylate group.

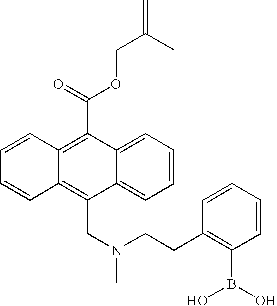

The skilled person in the art would be able to prepare alternative indicator monomers having the required polymerisable groups, using analogous methods or other techniques known in the art.

In one embodiment of the invention, the fibre is polymerised solely with the indicator monomer to provide a fibre linked to one or more polymers made up of multiple units derived from the indicator monomer. However, in a preferred embodiment, a matrix-forming monomer, i.e. a chain extender and/or cross linking agent is also present in the polymerisation mixture.

In a particularly preferred embodiment, a hydrogel-forming monomer is used as a chain extender. A hydrogel forming monomer is a hydrophilic material, which on polymerisation will provide a hydrogel (i.e. a highly hydrophilic polymer capable of absorbing large amounts of water). Examples of hydrogel-forming monomers include acrylates having hydrophilic groups such as hydroxyl groups (e.g. hydroxy ethyl methacrylate (HEMA)), acrylamide, vinylacetate, N-vinylpyrrolidone and similar materials. HEMA is preferred. Hydrogels made from such materials are well known in the biological field, for example for use in sensors. Alternative or additional chain extenders may be used if desired, for example ethylene glycol methacrylate, or polyethylene glycol methacrylate.

Examples of cross linkers which can be used include dimethacrylates or diacrylates. Ethylene glycol dimethacrylate is preferred. Polyethylene glycol dimethacrylates, bisacrylamide and N,N-methylene bisacrylamide can also be used.

The polymerisation is generally carried out by immersing the functionalised fibre (or at least a part of the fibre which has been functionalised, e.g. the tip) into a polymerisation mixture comprising the desired monomers and initiating polymerisation. The polymerisation reaction may be initiated by any suitable means such as by heating or applying UV light. UV light is preferred as it is typically less damaging to the materials involved. In particular where a hydrogel-forming monomer is used, excessive heating can be problematic since it dries out the hydrogel.

An initiator is generally added to initiate the polymerisation reaction. Suitable initiators will be well known in the art. Examples of photoinitiators where UV light is used include Irgacure® 651 (2,2-dimethoxy-1,2-diphenylethan-1-one) and Irgacure® 819 (bis acyl phosphine) (Ciba-Geigy). Examples of thermal initiators include AIPD (2,2′-azobis[2-([2-(2-imidazolin-2-yl)propane] dihydrochloride) and AIBN (2,2′-azobis (2-methylpropionitrile)).

All monomers are typically included in the polymerisation mixture prior to initiation of the reaction. However, further monomers can be added to the polymerisation mixture as the polymerisation reaction proceeds if desired.

The polymerisation mixture preferably comprises a mixture of initiator monomer and hydrogel-forming monomer and optionally a cross-linking agent. The hydrogel-forming monomer generally makes up the majority of the polymerisation mixture. The indicator monomer is preferably present at a concentration of from 10⁻⁶ to 10⁻²M in the hydrogel-forming monomer. The concentration of the cross-linker, if used, can be varied to control the diffusion and mechanical properties of the resulting polymer. For example, the porosity and hydrophilicity of the polymer may be varied dependent on the amount and nature of the cross-linker.

The fibre produced by the polymerisation reaction has covalently linked to its surface one or more polymers which comprise units derived from the indicator monomer. The units derived from the indicator monomer may form 100% of the polymers, but preferably make up no more than 50% by weight, e.g. no more than 20%, 10% or 5% by weight of the polymer. The units derived from the indicator may, for example make up at least 0.5%, or at least 1% or 2% by weight of the polymer. Typically, the polymers are formed from at least about 20%, e.g. at least 50%, 80%, 90% or 95% by weight units derived from a hydrogel-forming monomer, for example up to 99.5%, or up to 99% or 98% by weight of units derived from the hydrogel-forming monomer. Typically, from 0 to 80% by weight of the polymer is made up of cross-linker units.

The plastic optical fibres of the invention are useful as sensors, in particular as invasive or implantable sensors. A glucose sensor is particularly envisaged wherein a glucose indicator (e.g. containing a boronic acid receptor and a fluorophore) and a hydrogel are covalently linked to one another and to the plastic optical fibre. However, the invention may find use in any field where optical sensors including indicator chemistries are used.

### EXAMPLE

### Step 1: Chemical Functionalisation of Plastic Fibre Using RF Plasma

A PMMA (polymethylmethacrylate) optical fibre is placed in an RF chamber and the chamber is evacuated to 0.1 Torr. The chamber pressure is maintained and a gas mixture comprising 55% H₂ and 45% N₂ is introduced to a set flow rate. On stabilisation of the chamber pressure (typically the vacuum moves to 0.4 Torr on gas introduction) the RF power is switched on to the chamber reflector plates. The RF power is 240 W. The gas mix in the chamber is ionised by the RF and the ions modify the surface of the optical fibre in the chamber.

### Step 2: Introduction of Polymerisable Group Onto Fibre

The fibre prepared in accordance with step 1 is dipped into a solution of 2 cm³ of acryloyl chloride in 20 cm³ of dry diethyl ether (with the addition of proton sponge material (1,8 bis (dimethylamino) naphthalene) to react with hydrogen chloride that is evolved). This is left for 5 minutes at room temperature, and then the excess materials removed by evaporation. The fibre has now been functionalised with acrylamide which has a double bond and can be copolymerised with other monomers.

### Step 3: Polymerisation

A monoboronic acid glucose receptor linked to an anthracene fluorophore that has been derivatised with a methacrylate group is co-polymerised with (a) polyhydroxyethyl methacyrylate and (b) the acrylamide functionalised PMMA fibre prepared in step 2. The reaction conditions of the polymerisation, and the preparation of the glucose receptor, are described by Wang et al, Bioorganic chemistry, 29, 308-320 (2001).

1. A process for covalently linking an indicator to a plastic optical fibre, which process comprises:
(i) functionalising a plastic optical fibre to provide a functionalised fibre having one or more polymerisable groups; and
(ii) polymerising the functionalised fibre with an indicator monomer comprising at least one polymerisable group.

2. A process according to claim 1, wherein the functionalising step comprises (ia) contacting the fibre with a plasma to generate one or more reactive groups on the surface of the fibre, and (ib) converting the reactive group(s) to polymerisable group(s).

3. A process according to claim 2, wherein step (ia) comprises contacting the fibre with a N₂/H₂ radio frequency plasma to generate one or more amine groups on the surface of the fibre.

4. A process according to claim 1, wherein the indicator monomer is molecule comprising a polymerisable group, a boronic acid receptor group and a fluorophore group.

5. A process according to claim 1, wherein a hydrogel-forming monomer is included in the polymerisation step.

6. A process according to claim 1, wherein a cross-linking agent is included in the polymerisation step.

7. A plastic optical fibre which is covalently linked to an indicator or to a polymer comprising an indicator.

8. A plastic optical fibre according to claim 7, wherein the fibre is linked to a hydrogel comprising the indicator.

9. A plastic optical fibre according to claim 7, wherein the indicator comprises a boronic acid receptor group and a fluorophore group.

10. A sensor comprising a plastic optical fibre which is covalently linked to an indicator or to a polymer comprising an indicator.

11. A sensor according to claim 10, wherein the fibre is linked to a hydrogel comprising the indicator.
